(19) United States
(12) Patent Application Publication
(10) Pub. No.: US 2018/0367979 A1
(43) Pub. Date: Dec. 20, 2018

(54) SYSTEM AND METHOD FOR FACILITATING ACCESS TO NETWORK APPLICATIONS

(71) Applicant: Alibaba Group Holding Limited, George Town (KY)

(72) Inventor: Chunhui Zhu, Hangzhou (CN)

(73) Assignee: Alibaba Group Holding Limited, George Town (KY)

(21) Appl. No.: 16/000,705

(22) Filed: Jun. 5, 2018

(30) Foreign Application Priority Data
Jun. 15, 2017 (CN) 201710452524.8

(51) Int. Cl. H04W 8/08; H04W 12/06; H04L 29/06; H04L 29/12

(52) U.S. Cl. CPC H04W 8/08; H04W 12/06; H04L 12/4641; H04L 61/2015; H04L 63/083

(57) ABSTRACT

Embodiments described herein provide a system for facilitating service access to a user device without a roaming subscription in a network. During operation, the user device sends a first message, which includes a service access request, to a mobility management entity via a wireless access node. The service access request indicates that the user device intends to access a service. The user device then receives a service access permission via the wireless access node. In response, the user device sends a service access request to a service server that provides the requested service and receives an authentication portal from an authentication server. The authentication portal allows a user to select the requested service from one or more services provided in the network and enter service credentials associated with the selected service. Subsequently, the user device sends the service credentials obtained from the authentication portal to the authentication server.

### RELATED APPLICATION

Under 35 U.S.C. § 119, this application claims the benefit and right of priority of Chinese Patent Application No. 201710452524.8, filed 15 Jun. 2017.

### BACKGROUND

### Field

This disclosure is generally related to the field of computer networks. More specifically, this disclosure is related to a system and method for facilitating access to services in a visitor wireless network (i.e., not in a home network) without subscribing to roaming.

### Related Art

The proliferation of the Internet and e-commerce continues to create a vast amount of online services (e.g., Internet-based services). This allows these services to be offered across different countries, leading to globalization of these services. Many users access these services using applications running mobile user devices (or user equipments (UEs)), such as smartphones. Since the same service (e.g., a mobile payment service) can be offered in many countries, a user of such a service may intend to access the service from the user device in a visitor network (e.g., in a third/fourth generation (3G/4G) network abroad).

However, if the user does not subscribe to a roaming service or has exceeded the data usage limit of the roaming agreement, the user may not be able to access the service without roaming. For example, in a visitor network, a roaming user device may establish a wireless connection with an evolved NodeB (eNodeB or eNB) and send identity information (e.g., a mobile phone number) to a mobility management entity (MME) through the eNB. The MME can determine a home subscriber server (HSS), which maintains subscription information of the user, and send the identity information and an MME number to the HSS. If the HSS determines that the user does not subscribe to a roaming service, the identity authentication fails, and a message of identity authentication failure is returned to the MME. The MME then rejects the access of the user device based on the identity authentication failure.

As described above, when a local operator does not authenticate the user device, the user device may not access an application server via a guest or foreign wireless network. Even if the user only intends to use a specialized service (e.g., a mobile payment service for paying at a vending machine), the user device may not be able access that service.

While network services bring many desirable features to a user device, some issues remain unsolved in facilitating efficient access to these network services without subscribing to roaming services.

### SUMMARY

Embodiments described herein provide a system for facilitating service access to a user device without a roaming subscription in a network. During operation, the user device sends a first message, which includes a service access request, to a mobility management entity via a wireless access node. The service access request indicates that the user device intends to access a service. The user device then receives a service access permission via the wireless access node. The service access permission indicates that the user device is permitted to initiate a connection request for accessing the requested service. In response, the user device sends a service access request to a service server that provides the requested service and receives an authentication portal from an authentication server. The authentication portal allows a user to select, at the user device, the requested service from one or more services provided in the network and enter service credentials associated with the selected service. Subsequently, the user device sends the service credentials obtained from the authentication portal to the authentication server.

In a variation on this embodiment, the user device receives an Internet Protocol (IP) address for the user device and assigns the IP address to the user device

In a further variation, the user device sets the IP address as a source address of the service access request. This allows the authentication server to identify traffic from the user device.

In a variation on this embodiment, the first message also includes a network identity of the user device. The network identity can be one or more of: a mobile phone number and an international mobile subscriber identification (IMSI) number.

In a variation on this embodiment, the service access request is forwarded via a bearer connection associated with the wireless access node. The bearer connection is configured to allow traffic only between the user device and the authentication server.

In a variation on this embodiment, the user device receives the service credentials via a user interface of the user device. The service credentials include one or more of: a username associated with the requested service, a password associated with the username, and one or more additional credentials fields associated with the requested service.

In a variation on this embodiment, the service access request includes a flag or a bit pattern in a payload or header of the first message.

Embodiments described herein provide a system for facilitating service access to a user device without a roaming subscription in a network. During operation, the system determines that the user device intends to access a service based on a service access request in a first message received from the user device via a wireless access node. The system forwards the service access request to a gateway associated with the wireless access node. The system then obtains information associated with a bearer connection between the wireless access node and the gateway, and a network identifier allocated to the user device. The system sends the information associated with the bearer connection to the wireless access node. This allows the wireless access node to complete the bearer connection. Subsequently, the system sends the network identifier to the user device, thereby assigning the network identifier to the user device.

In a variation on this embodiment, the first message also includes a network identity of the user device. The network identity can be one or more of: a mobile phone number and an IMSI number.

In a further variation, the system bypasses authentication of the user device based on the network identity of the user device.

In a variation on this embodiment, the bearer connection allows traffic only between the user device and an authentication server.

In a variation on this embodiment, the network identifier is an Internet Protocol (IP) address allocated by an address allocation service running on the gateway.

In a variation on this embodiment, the system sends to the user device a service access permission indicating that the user device is permitted to initiate a connection request for accessing the requested service.

In a variation on this embodiment, the service access request includes a flag or a bit pattern in a payload or header of the first message.

In a variation on this embodiment, the system determines a cost for the traffic associated with the service access of the user device. A payment associated with the cost can be obtained from one or more of: (i) an account associated with the selected service, and (ii) a provider of a service that is supported by an Internet service server (ISS) and has been accessed by the user device.

Embodiments described herein provide a system for facilitating service access to a user device without a roaming subscription in a network. During operation, the system obtains a connection request from the user device and provides information associated with an authentication portal to the user device. The authentication portal allows a user to select a service provided in the network and enter service credentials associated with the selected service. The system then forwards the service credentials obtained from the authentication portal to an Internet service server (ISS) associated with the selected service. If the system determines a successful authentication from the ISS, the system allows data traffic between the user device and the ISS to pass.

In a variation on this embodiment, if the system determines an unsuccessful authentication from the ISS, the system determines whether a number of times the unsuccessful authentication has been generated has reached a threshold. If the number has not reached the threshold, the system sends an error message to the user device. If the number has reached the threshold, the system sends an authentication unsuccessful notification to the user device.

In a variation on this embodiment, the information associated with the authentication portal includes one or more of: a list of services supported by the network, a username field, a password field, and one or more additional credentials fields.

In a variation on this embodiment, the system identifies a network address as a source address of the connection request and if the authentication is successful, records the network address as an authenticated address in a service record.

In a further variation, the system allows data traffic between the user device and the ISS to pass by allowing data packets between the network address to the ISS to pass and allowing data packets sent from the ISS to the network address to pass.

In a variation on this embodiment, the system collects network statistics associated with data traffic between the user device and the ISS.

### BRIEF DESCRIPTION OF THE FIGURES

FIG. 1 illustrates an exemplary network environment facilitating service access without roaming, in accordance with an embodiment of the present application.

FIG. 2A illustrates an exemplary process of facilitating service access in a visitor wireless network without roaming, in accordance with an embodiment of the present application.

FIG. 2B illustrates an exemplary communication for facilitating service access in a visitor wireless network without roaming, in accordance with an embodiment of the present application.

FIG. 3 illustrates an exemplary portal for authenticating service access in a visitor wireless network without roaming, in accordance with an embodiment of the present application.

FIG. 4A illustrates exemplary service access request and grant messages for service access in a visitor wireless network without roaming, in accordance with an embodiment of the present application.

FIG. 4B illustrates an exemplary service mapping for configuring a bearer connection for carrying service access in a visitor wireless network without roaming, in accordance with an embodiment of the present application.

FIG. 5A presents a flowchart illustrating a method of a user device establishing service access in a visitor wireless network without roaming, in accordance with an embodiment of the present application.

FIG. 5B presents a flowchart illustrating a method of a user device requesting a service in a visitor wireless network without roaming, in accordance with an embodiment of the present application.

FIG. 5C presents a flowchart illustrating a method of a user device authenticating a service via a service portal, in accordance with an embodiment of the present application.

FIG. 6A presents a flowchart illustrating a method of an MME facilitating service access to a user device in a visitor wireless network without roaming, in accordance with an embodiment of the present application.

FIG. 6B presents a flowchart illustrating a method of a gateway establishing a bearer connection for carrying service access without roaming, in accordance with an embodiment of the present application.

FIG. 6C presents a flowchart illustrating a method of a local service server (LSS) authenticating a user device for a service, in accordance with an embodiment of the present application.

FIG. 7 illustrates an exemplary computer system that facilitates service access in a visitor wireless network without roaming, in accordance with an embodiment of the present application.

FIG. 8 illustrates an exemplary apparatus that facilitates service access in a visitor wireless network without roaming, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of providing service access to a user device in a visitor wireless network without roaming by (i) establishing a “service-only” connection between the user device and a service server; and (ii) authenticating the user device using the credentials associated with the requested service. The service-only connection can be configured to carry only service traffic, thereby allowing a visitor wireless network to provide that service to the user device without roaming.

Suppose that the user device uses a service (e.g., using an app facilitating the service) that is provided at a location outside of a home network (e.g., in a visitor network). If the user device roams into the visitor network (e.g., the user of the device travels to the corresponding location), the user device may need to access the service. For example, if the service is ride-sharing, the user device may use the corresponding application to request a ride. Similarly, if the service is an online payment service (e.g., PayPal or Alipay), the user device may use the corresponding application to make a payment. However, the user device may need to exchange data with an Internet service server (ISS) that facilitates the service.

With existing technologies, service access relies on roaming subscriptions to communicate with the ISS. To access a service in a visitor network, the user device establishes a wireless connection with a wireless access node (e.g., an eNodeB) and identifies itself with an MME. The MME then verifies subscription information of the user device with an HSS. If the HSS determines that the user subscribes to a roaming service, the MME allows the user device to exchange data traffic (e.g., to access the Internet) through the visitor wireless network. The user device then uses that data traffic to access a service from the ISS. However, if the user device is not associated with a roaming service, the identity authentication fails for that user device. The MME then rejects the access request of the user device based on the authentication failure. As a result, the user device may not exchange data traffic, hence, may not access the ISS for the corresponding service.

To solve this problem, embodiments described herein allow a visitor network to facilitate a service-only connection to a user device if the user device requests a local service that can be provided without roaming. During operation, a user device establishes a wireless connection with a wireless access node (e.g., an eNobeB) and sends a service access request message to the corresponding MME. In some embodiments, the user device includes a “local service access request” in the message to indicate that the user device intends to use a service. The MME provides this request to a gateway, which in turn, establishes a “service-only” bearer connection that is configured to access a local service server (LSS) that can facilitate accessing local services. The gateway can also allocate an Internet Protocol (IP) address for the user device.

The MME notifies the wireless access node regarding the bearer connection, thereby completing the establishment of the bearer connection between the wireless access node and the gateway. This bearer connection is dedicated for the user device. The MME also sends a service access grant message and the IP address to the wireless access node. The wireless access node then provides the IP address to the user device. The user device uses the IP address as a source address to initiate a service request. This request is carried via the bearer connection to the LSS. Upon receiving the request, the LSS provides an authentication portal to the user device. The user of the user device can enter the service credentials (e.g., the username and password) associated with the requested service in the authentication portal.

As an authentication proxy, the LSS forwards the credentials to the corresponding ISS. If the ISS successfully authenticates the user, the LSS records the successful authentication for the user device and initiates a service connection (e.g., a tunnel) between the IP address of the user device and an IP address of the ISS. The LSS then allows subsequent packets belonging to the service connection (e.g., the packets between these two IP addresses) to pass. In this way, the visitor network can facilitate the service access to the user device without a roaming subscription.

The term “tunnel” refers to a data communication where one or more networking protocols are encapsulated using another networking protocol. Although the present disclosure is presented using examples based on a layer-3 encapsulation of a layer-2 protocol, “tunnel” should not be interpreted as limiting embodiments of the present disclosure to layer-2 and layer-3 protocols. A “tunnel” can be established for and using any networking layer, sub-layer, or a combination of networking layers. Examples of a tunnel include, but are not limited to, Virtual Extensible Local Area Network (VXLAN), Generic Routing Encapsulation (GRE), and its variations, such as Network Virtualization using GRE (NVGRE) and Open vSwitch GRE.

A “user device” or a user associated with a user device refers to an entity which communicates via a wireless network, such as the long term evolution (LTE) network.

The term “application” refers to an application running on a user device, which can issue an Input/Output (I/O) request for a service from a server providing the service.

### Exemplary Network Environment

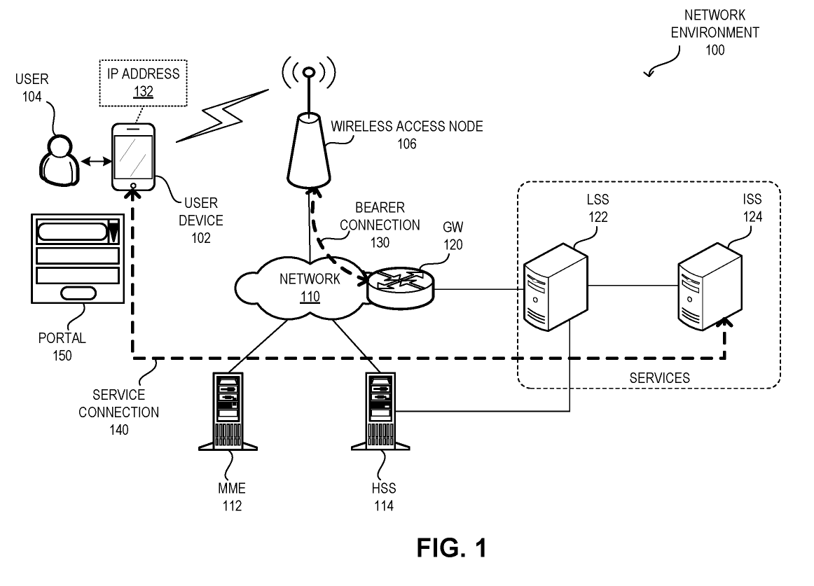

FIG. 1 illustrates an exemplary network environment facilitating service access without roaming, in accordance with an embodiment of the present application. In this example, a user device 102, which is associated with a user 104, relies on a network environment 100 for data exchange. Examples of computing device 102 can include, but are not limited to, a tablet, a mobile phone, an electronic reader, a laptop computer, a portable gaming device, and any other computing device that may support mobility. User device can include one or more user interfaces that allow user 104 to enter an input. Examples of a user interface can include, but are not limited to, a touch screen, a keyboard, a pointing device (e.g., a mouse), a camera (e.g., for detecting a gesture or recognizing a face), a scanner (e.g., a fingerprint scanner), and a movement detector (e.g., a gyroscope).

User device 102 can establish a wireless connection with a wireless access node 106 for communication (e.g., data exchange). Examples of node 106 can include, but are not limited to, a cellular access point (e.g., a base station or BTS, a NodeB, an eNodeB, or any next generation NodeB, such as a gNodeB), a Wi-Fi® access point (e.g., based on Institute of Electrical and Electronics Engineers (IEEE) 802.11 standards), and a cellular/Wi-Fi hotspot. User device 102 can also support satellite-based communication. Under such circumstances, a satellite may facilitative the operations of node 106.

Suppose that network environment 100 is a visitor network outside of a home network of user device 102. Network environment 100 can support one or more services that are provided in the home network of user device 102. If user 104 wishes to access one of the services, user device 102 may need to access the service in network environment 100. For example, if the service is ride-sharing, user device 102 may use the corresponding application to request a ride. Similarly, if the service is online payment, user device 102 may use the corresponding application to make a payment. However, user device 102 may need to exchange data with an ISS 124 that facilitates the service.

In network environment 100, node 106 provides a wireless interface to user device 102. Node 106 can be coupled to an MME 112 and an HSS 114 via a network 110. In this example, network 110 can represent a cellular backhaul network for node 106. MME 112 can be responsible for managing mobility and HSS 114 can be responsible for maintaining user subscription information in network environment 100. Therefore, to verify whether user device 102 has subscribed to a roaming service, MME 112 communicates with HSS 114 for authentication.

With existing technologies, since user device 102 is outside of its home network, user device 102 relies on a roaming subscription in network environment 100 to access the service. To access a service in network environment 100, user device 102 establishes a wireless connection with node 106 and identifies itself with MME 112 (e.g., using a mobile phone number). MME 112 then verifies subscription information of user device 102 by sending a verification message comprising the phone number, an authentication key, and an MME number associated with MME 112 to HSS 114. Based on the received information, if HSS 114 determines that user 102 subscribes to the roaming service, MME 112 allows user device 102 to exchange data traffic (e.g., to access the Internet) in network environment 100 via node 106.

Typically, user device 102 uses that data traffic exchange to access a service from ISS 124. However, a roaming service may be not available to user 104 in network environment 100. For example, user 104 may not subscribe to a roaming service or a data limit of an existing roaming service may have been exceeded for device 102 in network environment 100. Under such circumstances, MME 112 can reject the data access of user device 102 based on the authentication failure. This can preclude user device 102 from authenticating itself and exchanging data traffic. If user device 102 is not allowed to exchange data in network environment 100, user device 102 may not be able to communicate with ISS 124 for accessing the corresponding service.

To solve this problem, network environment 100, which may operate as a visitor network for user device 102, facilitates a service-only connection to user device 102 if user 104 intends to access a local service that can be locally provided. During operation, user device 102 establishes a wireless connection with node 106 and sends a service access request message to MME 112. User device 102 may include a “local service access request” in the message to indicate that user device 102 intends to use a service that can be locally provided. MME 112 provides this request to a gateway 120 (e.g., an LTE gateway), which, in turn, establishes a “service-only” bearer connection 130 (e.g., a cellular bearer connection dedicated for user device 102) that is configured to access an LSS 122. Gateway 120 can also allocate an IP address 132 for user device 102. It should be noted that LSS 122 can facilitate service access and corresponding service authentication in network environment 100.

MME 112 then notifies node 106 regarding bearer connection 130. Node 106 then completes the establishment of bearer connection 130 between node 106 and gateway 120. MME 112 also sends a service access grant message and IP address 132 to node 106. Node 106 then provides IP address 132 to user device 102, which configures IP address 132 as a local address (i.e., assigns IP address 132 to user device 102). User device 102 then uses IP address 132 as a source address to initiate a service request. Upon receiving the request, LSS 122 provides an authentication portal 150 to user device 102. User 104 can select a local service supported by network environment 100 from portal 150 and enter the service credentials (e.g., the username and password) associated with the selected service in portal 150. The selected service can be referred to as an authentication service.

As an authentication proxy, LSS 122 forwards the credentials to ISS 124, which is the server that provides the selected service. For example, if the selected service is an online payment service, ISS 124 can be the server facilitating the online payment process. If ISS 124 successfully authenticates user 104, LSS 122 records the successful authentication for user device 102 and initiates a service connection 140 between IP address 132 of user device 102 and an IP address of ISS 124. A respective service presented in portal 150 can be supported by ISS 124. In some embodiments, network 100 can include a plurality of Internet service servers, each facilitating one or more services supported by network 100. Recording the successful authentication for user device 102 includes recording IP address 132 as an authenticated address in a service record maintained by LSS 122. In this way, LSS 122 operates as an authentication server in network 100.

LSS 122 then allows subsequent packets belonging to service connection 140 (e.g., the packets between these two IP addresses) to pass. In this way, network environment 100 allows data exchange between user device 102 and LSS 122 to facilitate the service access to user device 102 without a roaming subscription and being limited by a network authentication from HSS 114. In other words, network environment 100 can facilitate the service access to user device 102 bypassing authentication of the network identity of user device 102 with HSS 114. In some embodiments, ISS 124 may operate as a proxy for other services. For example, ISS 124 can facilitate an online payment service (e.g., PayPal) and can operate as a proxy for an online retailer service that uses that online payment service (e.g., Amazon or eBay). In this way, ISS 124 can support both the online payment service and the online retailer service.

### Service Access

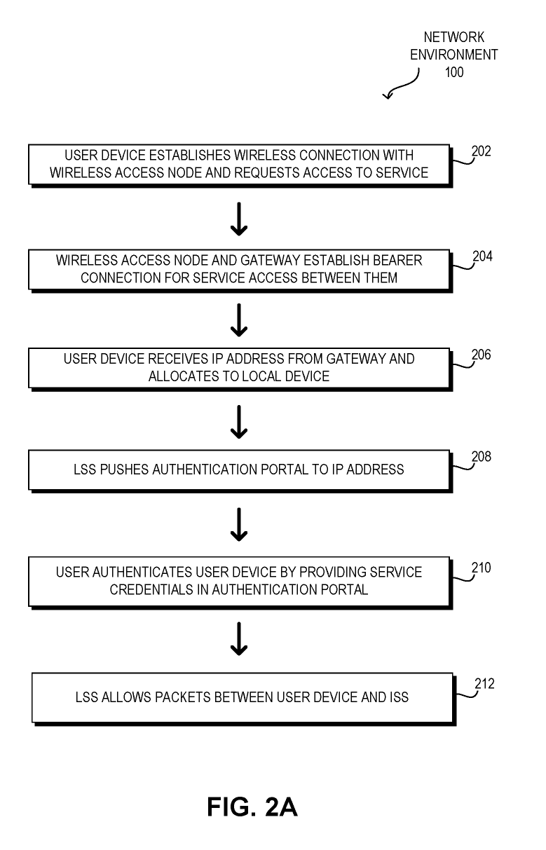

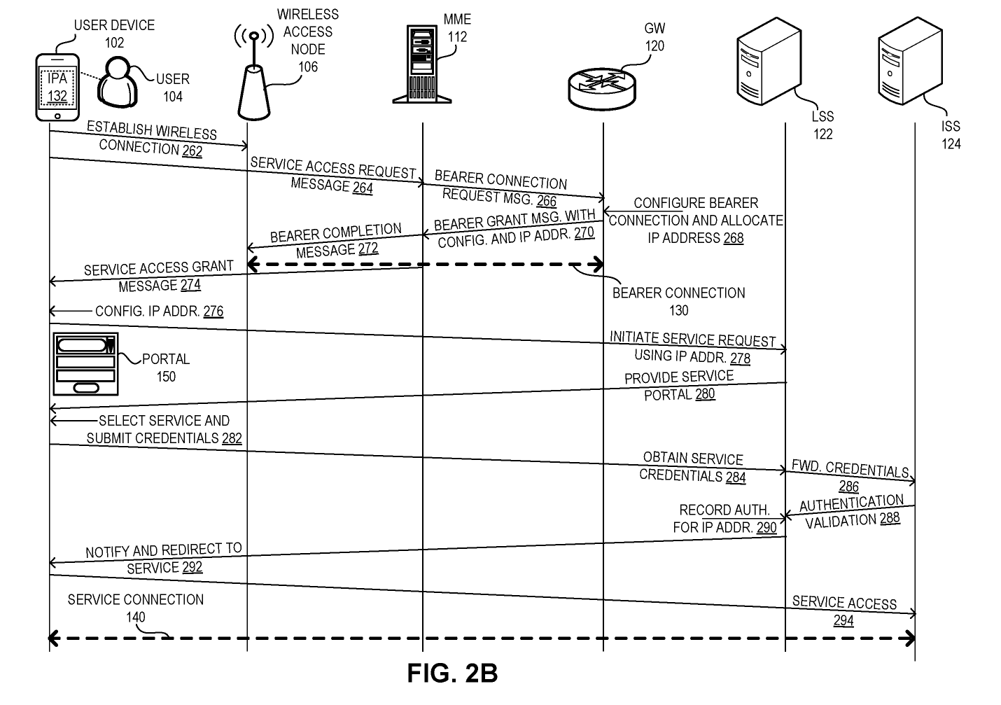

FIG. 2A illustrates an exemplary process of facilitating service access in a visitor wireless network without roaming, in accordance with an embodiment of the present application. In this example, network environment 100 can be the visitor wireless network. During operation, a user device establishes a wireless connection with a wireless access node and requests access to a service (operation 202). The wireless access node and a corresponding gateway then establish a bearer connection for service access between them (operation 204). The user device receives an IP address from the gateway and allocates the IP address to the local device (operation 206).

The LSS then pushes an authentication portal to the IP address (i.e., the user device) (operation 208). In some embodiments, the user device initiates a connection, such as an Internet connection, using the IP address as the source address. The LSS receives the corresponding initial packet and pushes the authentication portal to the IP address. The user, in response, can authenticate the user device, hence the IP address, by providing the service credentials in the authentication portal (operation 210). Upon successful authentication, the LSS allows packets between the user device and the ISS (operation 212), thereby facilitating service access to the user device.

FIG. 2B illustrates an exemplary communication for facilitating service access in a visitor wireless network without roaming, in accordance with an embodiment of the present application. It should be noted that FIG. 2B further elaborates upon the processes described in conjunction with FIG. 2A. During operation, user device 102 establishes a wireless connection with wireless access node 106 (operation 262) and sends a service access request message to MME 112 (operation 264). In some embodiments, user device 102 includes a “local service access request” (e.g., a flag, a bit pattern, or a field in the header of the message) in the service access request message. The service access request message can also include the mobile network identity information of user device 102.

Upon identifying the “local service access request” in the message, MME 112 determines that user device 102 intends to access a locally provided service. MME 112 then sends a bearer connection request message to gateway 120 (operation 266). MME 112 can include the “local service access request” in the bearer connection request message. Upon receiving the bearer connection request message, gateway 120 configures a “service-only” bearer connection 130 and allocates IP address 132 to user device 102 (operation 268). In other words, gateway 120 configures bearer connection 130 such that bearer connection 130 can only access an LSS.

Gateway 120 can obtain a pre-configuration associated with the “local service access request” and configure bearer connection 130 accordingly. Gateway 120 can also allocate IP address 132 to user device 102. Gateway 120 then sends a bearer grant message with the configuration of bearer connection 130 and IP address 132 (operation 270). MME 112 sends a bearer completion message to wireless access node 106 (operation 272). The bearer completion message can include the configuration of bearer connection 130. Upon receiving the bearer completion message, wireless access node 106 uses the configuration to complete the establishment of bearer connection 130.

MME 112 also sends a service access grant message to user device 102 informing user device 102 that the service access has been granted (operation 274). In some embodiments, MME 112 includes a “local service access permission” (e.g., a flag, a bit pattern, or a field in the header of the message) and IP address 132 in the service access grant message. Upon identifying the “local service access permission” in the message, user device 102 determines that the service access has been granted. User device 102 then configures IP address 132 for the local device (i.e., assigns IP address 132 to user device 102) (operation 276).

User device 102 then initiates a service request using IP address 132 (operation 278). To do so, user device 102 uses IP address 132 as a source address for the request message and sends the request message via wireless access node 106 (e.g., open any web page). LSS 122 receives this service request and provides an authentication portal 150 to user device 102 (operation 280). User device 102 then allows user 104 to select a service from portal 150, fill in related service credentials (e.g., a username and a password), and submit the service credentials (operation 282). In some embodiments, user device 102 can be aware of the supported services. The “local service access request” can then identify which service user 104 intends to use. Under such circumstances, the requested service can be pre-selected in portal 150. It should be noted that the requested service and the service selected from the portal (i.e., the authentication service) can be different. However, ISS 124 may support both the requested service as well the authentication service.

LSS 122 obtains the service credentials via portal 150 (operation 284) and, as an authentication proxy, forwards the service credentials to the ISS, such as ISS 124, corresponding to the selected service (operation 286). If the service credentials are valid, the authentication succeeds. ISS 124 then authenticates user 104 and provides the authentication validation information to LSS 122 (operation 288). The validation information indicates that the service credentials are valid. When the authentication succeeds, LSS 122 receives the validation information. LSS 122 uses IP address 132 as an identifier of user device 102 and records that authentication has been successful for IP address 132 (i.e., for user device 102) (operation 290).

In some embodiments, LSS 122 can maintain a state (e.g., a flag in an authentication table) for user device 102 that indicates that IP address 132 has been validated. This causes LSS 122 to open communication from IP address 132 to ISS 124, including: allowing IP packets from IP address 132 as a source address to ISS 124 to pass, and allowing IP packets sent from ISS 124 to IP address 132 as a destination address to pass. LSS 122 then notifies user device 102 regarding the successful authentication (operation 292). LSS 122 can also redirect user device 102 to ISS 124 (e.g., provides the service page from ISS 124 to user device 102). User device 102 then accesses services from ISS 124 via LSS 122 (operation 294). This service access can include access to one or more services provided by ISS 124, which can include the service used for the authentication.

After user 104 has completed the authentication process using portal 150, user device 102 can access the service provided by ISS 124. LSS 122 can collect statistics on the traffic of user 104 accessing ISS 124. The operator of network environment 100 can determine the traffic generated by user 104 to access ISS 124 and may adjust the corresponding cost based on a commercial agreement. For example, an overseas mobile phone user, who may not successfully authenticate with a local mobile network in the USA, can access services through the local mobile network after successfully authenticating with the credentials. Related traffic costs can be paid by either a user account of user 104 associated with the service, or by the service provider that provides the requested service. For example, if user 104 uses an online payment service to authenticate and purchase an item from an online retailer service supported by ISS 124, the cost of the traffic generated by this purchase can be paid via the online payment service account of user 104 and/or by the online retailer service to encourage users to access its service.

### Authentication Portal

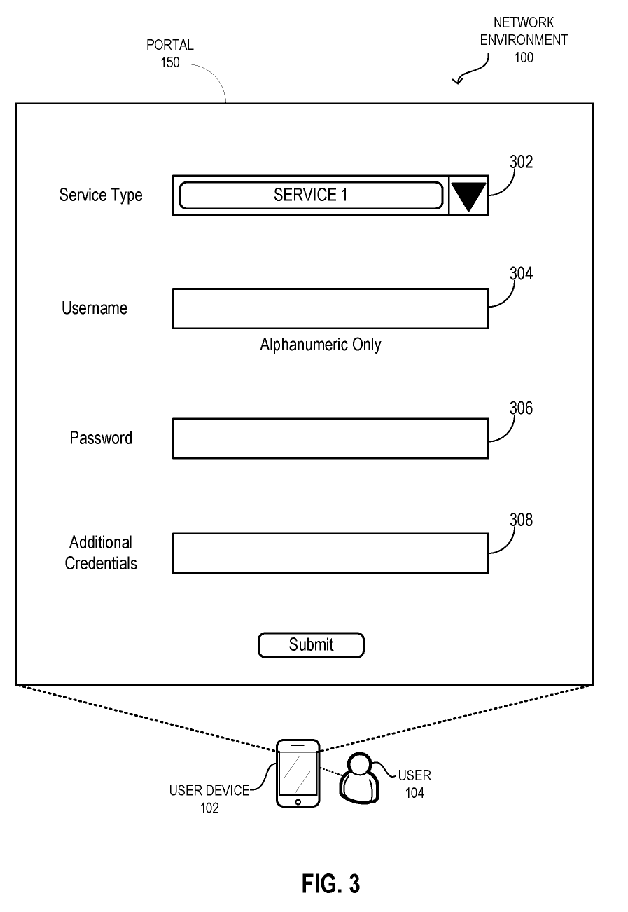

FIG. 3 illustrates an exemplary portal for authenticating service access in a visitor wireless network without roaming, in accordance with an embodiment of the present application. In this example, portal 150 can be a web page that facilitates the authentication of a service (e.g., a web page allowing user 104 to select a supported local service, and fill in a username and a password of the selected service). Upon receiving portal 150, user device 102 may present portal 150 to user 104 (e.g., in a web page or in a floating notification window of the operating system of user device 102). Portal 150 can include a number of fields that allow user 104 to enter service credentials associated with the requested service.

Portal 150 can include a drop-down menu 302 that lists the services supported by network environment 100. Instead of drop-down menu 302, portal 150 can include any other form of list from which user 104 can select a service. If network environment 100 supports two online payment services and two ride-sharing services, drop-down menu 302 can include each of the four services. User 104 can use drop-down menu 302 to select the service. Portal 150 can include an alphanumeric username field 304 and a password field (e.g., a field that hides user input) 306. Fields 304 and 306 allow user 104 to enter the service credentials associated with the selected service from drop-down menu 302. In some embodiments, if the selected service requires additional credentials (e.g., a personal identification number (PIN) or a verification code), portal 150 can include a corresponding additional credentials field 308.

### Service Access

As described in conjunction with FIG. 2B, user device 102 sends a service access request message, which requests access to a service provided by ISS 124, to MME 112. By sending the service access request message, user device 102 initiates the service access request process in network environment 100. When the user access is granted (e.g., by establishing bearer connection 130), MME 112 sends a service access grant message, which notifies that the requested service can be accessed, to user device 102. The service access grant message allows user device 102 to the access the requested service.

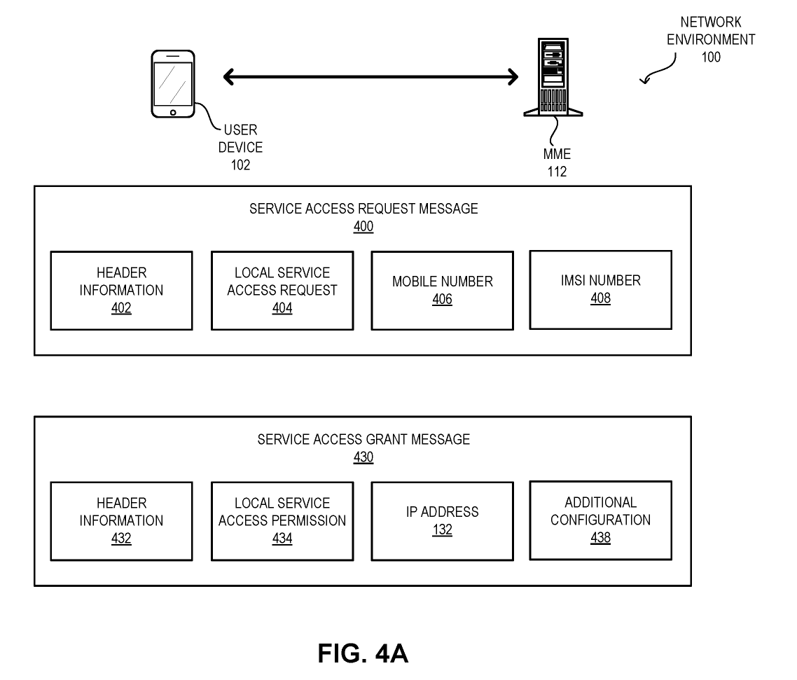

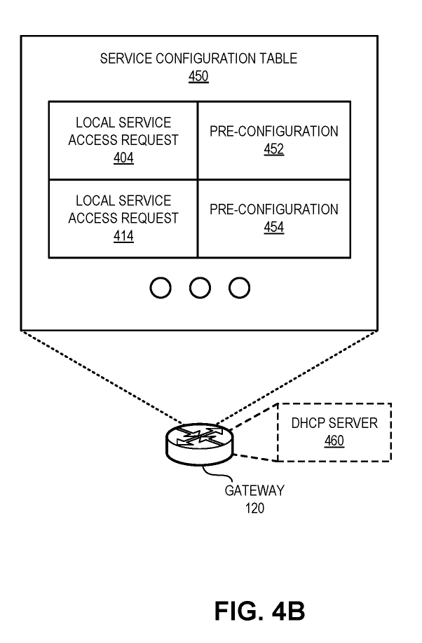

FIG. 4A illustrates exemplary service access request and grant messages for service access in a visitor wireless network without roaming, in accordance with an embodiment of the present application. During operation, user device 102 sends a service access request message 400 to MME 112. Since message 400 can be sent prior to the allocation of an IP address, message 400 can be a layer-2 broadcast message. Message 400 can include header information 402, which can include a layer-2 address (e.g., a media access control (MAC) address) of user device 102 as a source address and a layer-2 broadcast address as a destination address.

In some embodiments, user device 102 can include a “local service access request” 404 in message 400. Request 404 can be represented by a flag or a bit pattern in the payload of message 400, or a flag or a field in the header (e.g., in addition to header information 402) of message 400. Request 404 can be the same for any service supported by network environment 100. For example, a service offered globally can have a unique global code (e.g., an international identifier or a business identifier code, such as an International Organization for Standardization (ISO) 9362 code). User device 102 can include that code in request 404 to indicate the requested service. Request 404 can also indicate a type of service (e.g., ride-sharing, online payment, gaming, etc.), which can be indicated by a part of the global code.

To identify itself, user device 102 can also include the mobile network identity information of user device 102. Such identity information can include one or more of: a mobile number 406 and an international mobile subscriber identification (IMSI) number 408 of user device 102. MME 112 can use IMSI 408 to identify the network user device 102 belongs to (e.g., the home network), and whether user 104 may use a given network (e.g., a visitor network), such as network environment 100 in FIG. 1. Mobile number 406 can be the mobile number of the home network or a newly assigned number in the visitor network.

As described in conjunction with FIG. 2B, upon receiving message 400, MME 112 can establish bearer connection 130 to allow traffic between user device 102 and LSS 122. MME 112 then informs user device 102 that user 104 can access the requested service. To do so, MME 112 sends a service access grant message 430 to user device 102. Since message 430 can be sent after MME 112 learns the layer-2 address of user device 102, message 430 can be a layer-2 unicast message. Message 430 can include header information 432, which can include a layer-2 address of MME 112 as a source address and a layer-2 address of user device 102 as a destination address.

In some embodiments, user device 102 can include a “local service access permission” 434 in message 430. Permission 434 can be represented by a flag or a bit pattern in the payload of message 430, or a flag or a field in the header (e.g., in addition to header information 432) of message 430. In some embodiments, permission 434 can include the same bits as request 404. In other words, if permission 434 is the same as request 404, user device 102 determines that the permission to access the requested service has been granted. If permission 434 and request 404 are different, user device 102 may determine that the service access request has been denied. User device 102 then refrains from initiating the requested service access.

Message 430 can also include IP address 132 allocated to user device 102. If user device 102 determines that a permission to access the requested service has been granted, user device 102 may seek an IP address in message 430 (e.g., at a pre-determined bit location in the payload of message 430). MME 112 can also include additional configuration information 438 in message 430. Information 438 can include any additional information that user device 102 may need to access the requested service.

It should be noted that messages 400 and 430 can be any data messages. In this disclosure, the term “message” refers to a group of bits that can be transported together across a network. “Frame” should not be interpreted as limiting embodiments of the present disclosure to any layer of a network. “Message” can be replaced by other terminologies referring to a group of bits, such as “packet,” “cell,” “frame,” or “datagram.”

As described in conjunction with FIG. 2B, gateway 120 configures a “service-only” bearer connection 130 and allocates IP address 132 to user device 102. To do so, gateway 120 can maintain a set of pre-configurations corresponding to the local service access requests. FIG. 4B illustrates an exemplary service mapping for configuring a bearer connection for carrying service access in a visitor wireless network without roaming, in accordance with an embodiment of the present application. Gateway 120 maintains a service configuration table 450 that maps a local service access request, such as request 404, to a pre-configuration for a corresponding bearer connection.

If request 404 is the same for all services (i.e., request 404 indicates a request for any service), table 450 can include a mapping between request 404 and a corresponding pre-configuration 452 (e.g., for bearer connection 130 in FIG. 1). Pre-configuration 452 can indicate that bearer connection 130 can only access LSS 122. On the other hand, if request 404 is specific to a service or a type of service, pre-configuration 452 can also include service-specific configurations. For example, if request 404 indicates an online payment service, pre-configuration 452 can specify a corresponding encryption requirement associated with the service. For another local service access request 414 for another service, table 450 can maintain another mapping between request 414 and a pre-configuration 454 for a corresponding bearer connection.

Gateway 120 can obtain the pre-configuration associated with the “local service access request” and configure a bearer connection accordingly. For example, upon identifying request 404 in a message, gateway 120 looks up in table 450 using request 404 and obtains pre-configuration 452. Gateway 120 then configures bearer connection 130 based on pre-configuration 452. This allows gateway 120 to identify a service access and facilitate a “service-only” bearer connection without a manual intervention from a network administrator.

In some embodiments, gateway 120 can also host an IP address allocation service, such as a dynamic host configuration protocol (DHCP) server 460. Gateway 120 may use DHCP server 460 to allocate IP address 132 to user device 102. If a network administrator wishes to apply any filter (e.g., block a MAC address) to implement a policy, the network administrator can set that filter in DHCP server 460. For example, DHCP server 460 can be configured to issue an IP address if the MAC address of user device 102 is associated with certain manufacturers (e.g., using an organizationally unique identifier (OUI)). It should be noted that if gateway 120 does not issue an IP address to user device 102, gateway 120 may not set up a bearer connection for user device 102 and may notify MME 112 regarding the failure.

### Operations

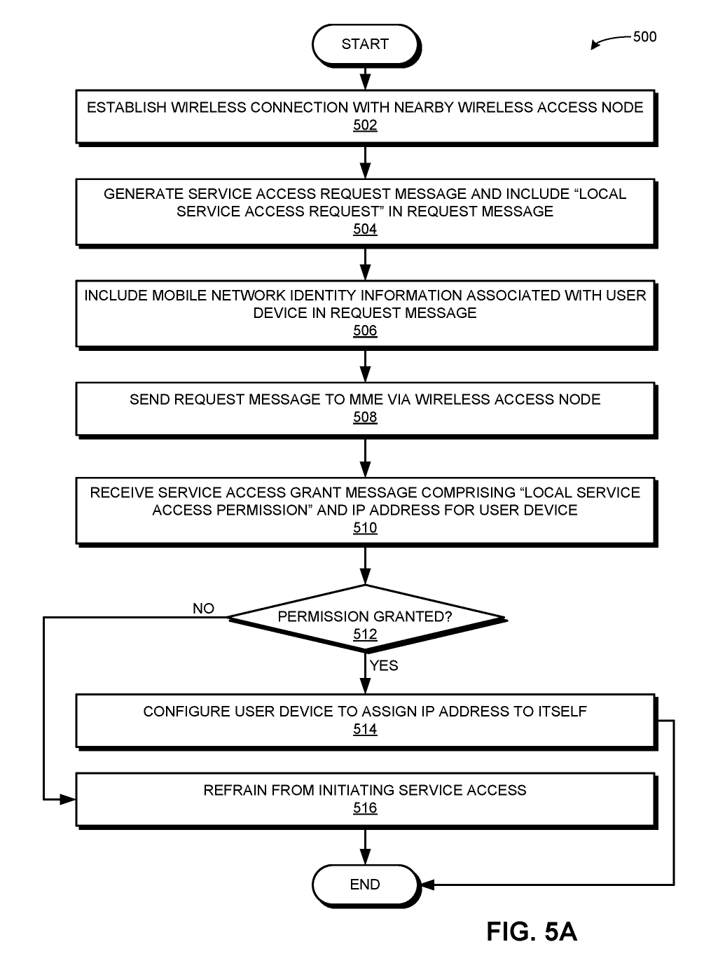

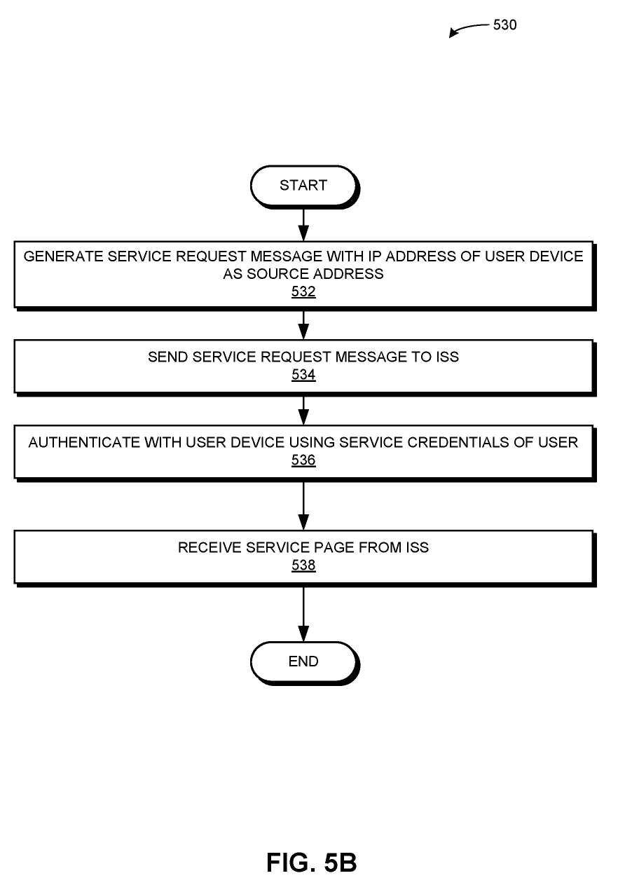

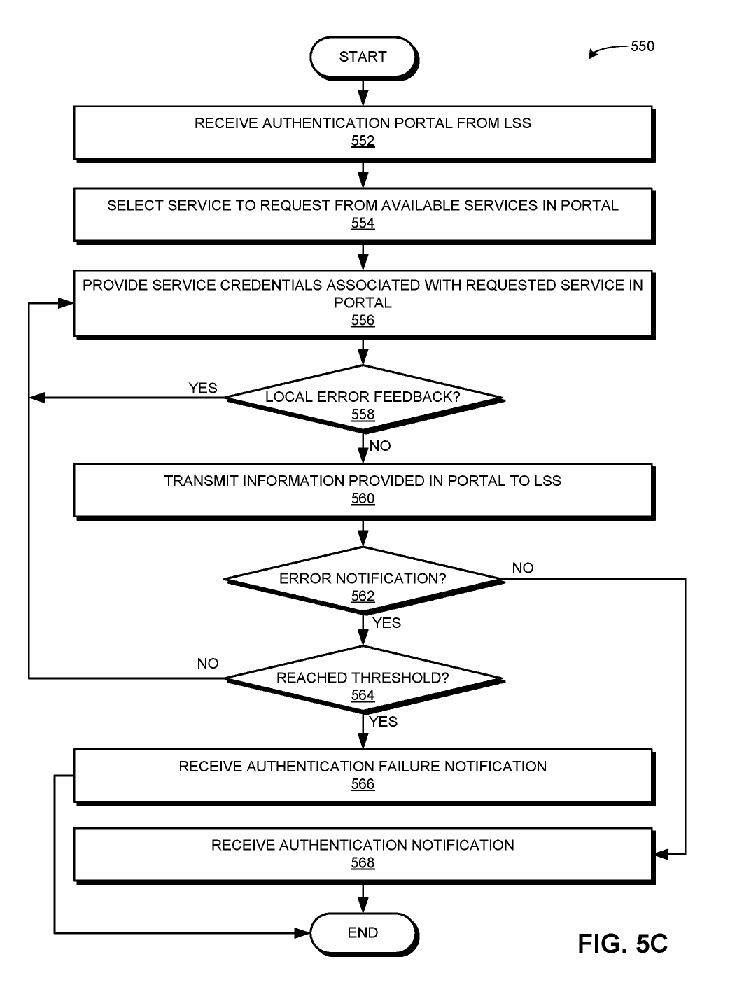

FIG. 5A presents a flowchart illustrating a method of a user device establishing service access in a visitor wireless network without roaming, in accordance with an embodiment of the present application. During operation, the user device establishes a wireless connection with a nearby wireless access node (operation 502). The user device may select the wireless access node based on received signal strength and noise. The user device then generates a service access request message and includes a “local service access request” in the request message (operation 504). The user device can also include mobile network identity information associated with the user device in the request message (operation 506).

The user device then sends the request message to an MME via the wireless access node (operation 508). The user device may broadcast the request message so that the message reaches the MME. The user device receives a service access grant message comprising a “local service access permission” and an IP address for the user device (operation 510). The user device checks whether a permission for service access has been granted based on the “local service access permission” (operation 512). If the permission has been granted, the user device configures the user device to assign the IP address to itself (operation 514). If the permission has not been granted, the user device refrains from initiating a service access (operation 516).

FIG. 5B presents a flowchart illustrating a method of a user device requesting a service in a visitor wireless network without roaming, in accordance with an embodiment of the present application. During operation, the user device generates a service request message with the IP address assigned to the user device as a source address (operation 532) and sends the service request message to the ISS associated with the service (operation 534). However, if the IP address of the ISS is not known to the user device, the user device can perform a name lookup using a domain name of the service (e.g., a domain name system (DNS) lookup).

Since the bearer connection allows traffic to the LSS, the LSS receives the service request (or the DNS lookup request). The LSS then sends an authentication portal to the user device. The user device can authenticate the user device using the service credentials of the user (operation 536). The service credentials of the user can include a username and a password associated with an service account (e.g., an account for accessing the service) of the user. If the authentication is successful, the LSS allows the ISS to send traffic to the user device. The user device then receives a service page from the ISS (operation 538). The service page can be a web page or an application screen that allows the user device to access the service.

FIG. 5C presents a flowchart illustrating a method of a user device authenticating a service via a service portal, in accordance with an embodiment of the present application. It should be noted that FIG. 5C further elaborates upon operation 536 of FIG. 5B. During operation, the user device receives an authentication portal from the LSS (operation 552) and selects a service to request from the available services in the portal (operation 554). The user device then provides the service credentials associated with the requested service in the portal (operation 556). The user device then checks whether the portal has provided a local error feedback (e.g., an incorrect format in the username) (operation 558).

If the portal has not provided a local error feedback, the user device transmits the information provided in the portal to the LSS (operation 560). If the credentials are not correct (e.g., due a typographical error), the LSS may resend the portal with an error notification. The user device checks whether the portal has provided an error notification from the LSS (operation 562). If the portal has not provided an error notification, the user device receives an authentication notification (operation 568). If the authentication is successful, the notification allows the user device to initiate a service access.

It should be noted that the LSS can allow a pre-determined number of attempts (e.g., a threshold) to authenticate the user. Hence, if the number of times the user device receives the error notification reaches the threshold (operation 564), the LSS may halt the authentication process for a period of time. The authentication process then fails for the user device and the user device receives an authentication failure notification (operation 566). If the portal has provided a local error feedback (operation 558) or the threshold for an error notification has not been reached (operation 564), the user device continues to provide the service credentials associated with the requested service in the portal (operation 556).

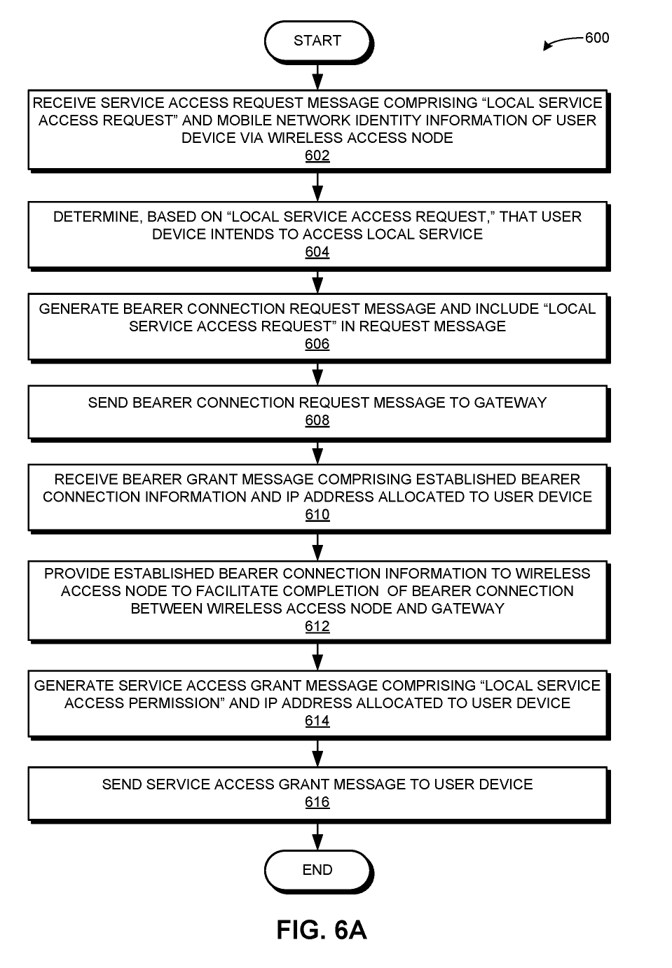

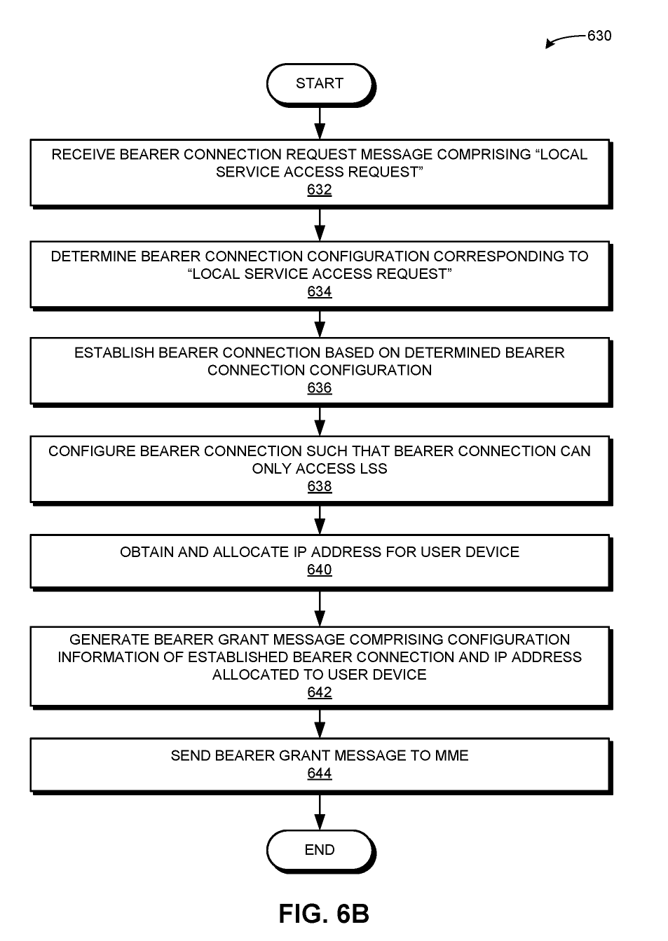

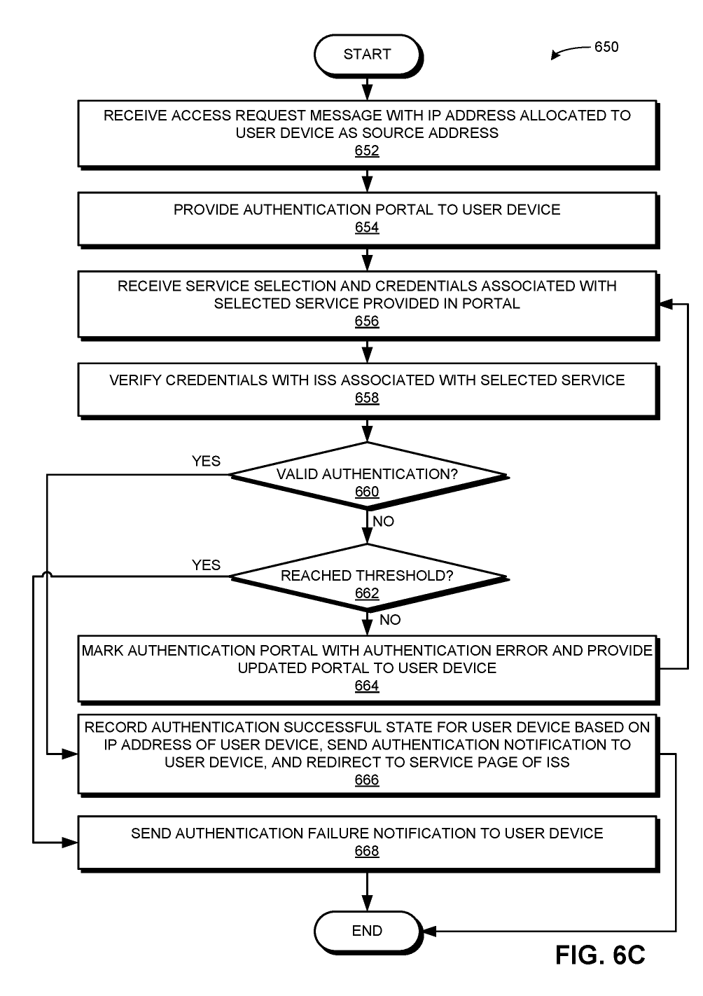

FIG. 6A presents a flowchart illustrating a method of an MME facilitating service access to a user device in a visitor wireless network without roaming, in accordance with an embodiment of the present application. During operation, the MME receives a service access request message comprising a “local service access request” and the mobile network identity information of the user device via a wireless access node (operation 602). The MME then determines, based on the “local service access request,” that the user device intends to access a local service (operation 604).

The MME generates a bearer connection request message and includes the “local service access request” in the request message (operation 606), and sends the request message to a gateway (operation 608). Based on this request message, the gateway establishes a “service-only” bearer connection. The MME receives, from the gateway, a bearer grant message comprising the established bearer connection information and an IP address allocated to the user device (operation 610).

The MME provides the established bearer connection information to the wireless access node (e.g., via a notification message) to facilitate the completion of the bearer connection between the wireless access node and the gateway (operation 612). The MME generates a service access grant message comprising a “local service access permission” and the IP address allocated to the user device (operation 614). The MME then sends the service access grant message to the user device (operation 616).

FIG. 6B presents a flowchart illustrating a method of a gateway establishing a bearer connection for carrying service access without roaming, in accordance with an embodiment of the present application. During operation, the gateway receives a bearer connection request message comprising “local service access request” (operation 632). The gateway then determines the bearer connection configuration corresponding to the “local service access request” (operation 634) and establishes a bearer connection based on the bearer connection configuration (operation 636).

The gateway also configures the bearer connection such that the bearer connection can only access the LSS (operation 638). The gateway obtains and allocates an IP address for the user device (operation 640). The gateway can use a DHCP server to allocate the IP address. The gateway then generates a bearer grant message comprising the configuration information of the established bearer connection and the IP address allocated to the user device (operation 642). The gateway sends the bearer grant message to the MME (operation 644).

FIG. 6C presents a flowchart illustrating a method of an LSS authenticating a user device for a service, in accordance with an embodiment of the present application. During operation, the LSS receives an access request message (or a name lookup message) with the IP address allocated to the user device as the source address (operation 652). The LSS provides an authentication portal to the user device (operation 654). The LSS receives service selection and the credentials associated with the selected service provided in the portal (operation 656). The LSS verifies the credentials with an ISS associated with the selected service (operation 658).

The LSS then determines whether the ISS has indicated a valid authentication (operation 660). The LSS can allow a pre-determined number of attempts (e.g., a threshold) to authenticate the user. Hence, if the response message does not indicate a valid authentication (operation 660), the LSS checks whether the number of times the user device generated an invalid authentication has reached the threshold (operation 662). If the threshold has been reached, the LSS may halt the authentication process for a period of time. The authentication process then fails for the user device and the LSS sends an authentication failure notification to the user device (operation 668).

If the ISS has not indicated a valid authentication (operation 660) and the threshold has not been reached (operation 662), the LSS marks the authentication portal with the authentication error (e.g., a statement indicating an incorrect username/password) and provides the updated portal to the user device (operation 664). The LSS then continues to receive service selection and the credentials associated with the selected service provided in the portal (operation 656). If the ISS has indicated a valid authentication (operation 660), the LSS records an authentication successful state for the user device based on the IP address of the user device (e.g., in a local table comprising IP addresses with successful authentication) (operation 666). The LSS can also send an authentication notification to the user device and may redirect the user device to the service page of the ISS (operation 666).

### Exemplary Computer System and Apparatus

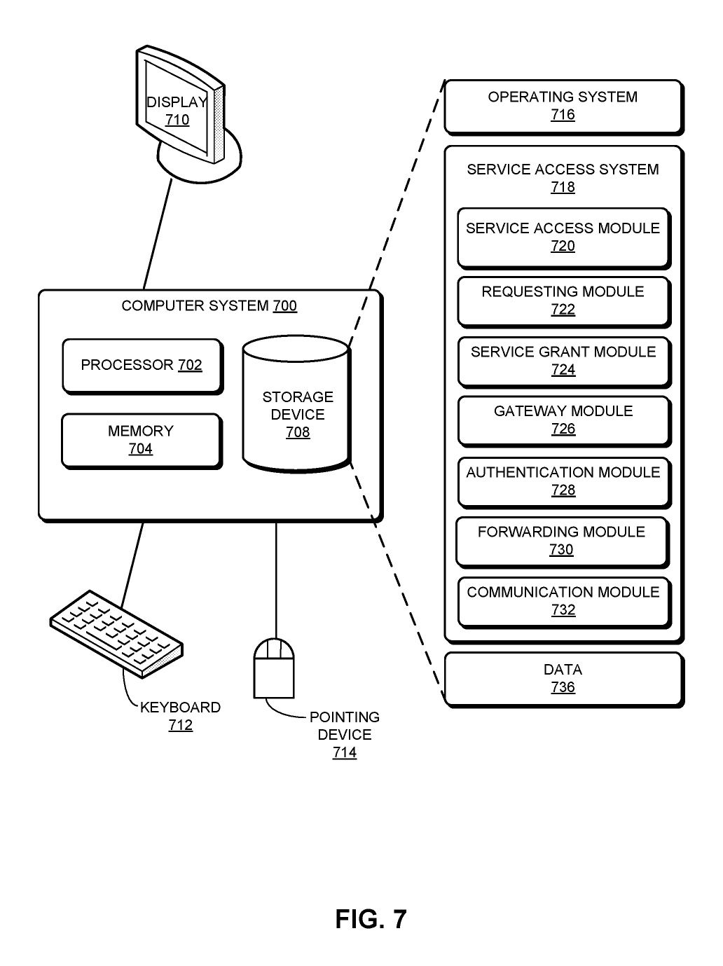

FIG. 7 illustrates an exemplary computer system that facilitates service access in a visitor wireless network without roaming, in accordance with an embodiment of the present application. Computer system 700 includes a processor 702, a memory 704, and a storage device 708. Memory 704 can include a volatile memory (e.g., a dual in-line memory module (DIMM)). Furthermore, computer system 700 can be coupled to a display device 710, a keyboard 712, and a pointing device 714. Storage device 708 can store an operating system 716, a service access system 718, and data 736. Service access system 718 can facilitate the operations of one or more of: user device 102, MME 112, gateway 120, and LSS 122.

Service access system 718 can include instructions, which when executed by computer system 700 can cause computer system 700 to perform methods and/or processes described in this disclosure. Specifically, service access system 718 can include instructions for a user device establishing service access in a visitor wireless network without roaming, such as requesting access to a local service and authenticating a user in an authentication portal (service access module 720). Service access system 718 can also include instructions for the user device requesting a service from an ISS (requesting module 722).

Furthermore, service access system 718 includes instructions for an MME facilitating service access to a user device in a visitor wireless network without roaming, such as notifying a gateway about the service access request and the user device about granting the access request (service grant module 724). Service access system 718 can also include instructions for a gateway establishing a “service-only” bearer connection and allocating an IP address to a user device (gateway module 726).

Service access system 718 can further include instructions for an LSS authenticating a user device based on an authentication portal (authentication module 728). Service access system 718 can also include instructions for an LSS forwarding a service access request to an ISS (forwarding module 730). Service access system 718 may further include instructions for a user device, an MME, a gateway, and/or an LSS sending and receiving messages (communication module 732).

Data 736 can include any data that can facilitate the operations of one or more of: user device 102, MME 112, gateway 120, and LSS 122. Data 736 may include one or more of: mobile network identity information, a service configuration table, an IP address allocation table of a DHCP server, and a service record indicating the IP addresses that are authenticated to access a service.

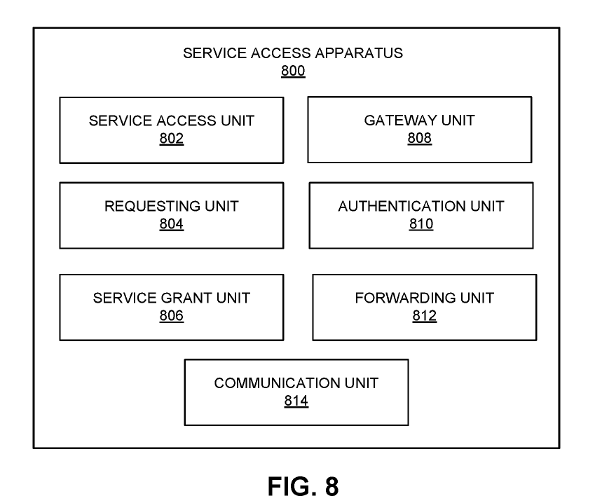

FIG. 8 illustrates an exemplary apparatus that facilitates service access in a visitor wireless network without roaming, in accordance with an embodiment of the present application. Service access apparatus 800 can comprise a plurality of units or apparatuses which may communicate with one another via a wired, wireless, quantum light, or electrical communication channel. Apparatus 800 may be realized using one or more integrated circuits, and may include fewer or more units or apparatuses than those shown in FIG. 8. Further, apparatus 800 may be integrated in a computer system, or realized as a separate device that is capable of communicating with other computer systems and/or devices. Specifically, apparatus 800 can comprise units 802-814, which perform functions or operations similar to modules 720-732 of computer system 700 of FIG. 7, including: a service access unit 802; a requesting unit 804; a service grant unit 806; a gateway unit 808; an authentication unit 810; a forwarding unit 812; and a communication unit 814.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating service access to a user device without a roaming subscription in a network, the method comprising:
sending a first message comprising a service access request to a mobility management entity via a wireless access node, wherein the service access request indicates that the user device intends to access a service;
receiving a service access permission via the wireless access node, wherein the service access permission indicates that the user device is permitted to initiate a connection request for accessing the requested service;
sending a service access request to a service server that provides the requested service;
receiving, from an authentication server, information associated with an authentication portal that allows a user to select the requested service from one or more services provided in the network and enter service credentials associated with the selected service; and
sending the service credentials obtained from the authentication portal to the authentication server.

2. The method of claim 1, further comprising:
receiving an Internet Protocol (IP) address for the user device; and
assigning the IP address to the user device.

3. The method of claim 2, further comprising setting the IP address as a source address of the service access request, thereby allowing the authentication server to identify traffic from the user device.

4. The method of claim 1, wherein the first message comprises a network identity of the user device, wherein the network identity comprises one or more of:
a mobile phone number; and
an international mobile subscriber identification (IMSI) number.

5. The method of claim 1, wherein the service access request is forwarded via a bearer connection associated with the wireless access node, and wherein the bearer connection is configured to allow traffic only between the user device and the authentication server.

6. The method of claim 1, further comprising receiving the service credentials via a user interface of the user device;
wherein the service credentials include one or more of:
a username associated with the requested service;
a password associated with the username; and
one or more additional credentials fields associated with the requested service.

7. The method of claim 1, wherein the service access request comprises a flag or a bit pattern in a payload or header of the first message.

8. A computer-implemented method for facilitating service access to a user device without a roaming subscription in a network, the method comprising:
determining that the user device intends to access a service based on a service access request in a first message received from the user device via a wireless access node;
forwarding the service access request to a gateway associated with the wireless access node;
obtaining information associated with a bearer connection between the wireless access node and the gateway from the gateway, and a network identifier allocated to the user device;
sending the information associated with the bearer connection to the wireless access node, thereby allowing the wireless access node to complete the bearer connection; and
sending the network identifier to the user device, thereby assigning the network identifier to the user device.

9. The method of claim 8, wherein the first message comprises a network identity of the user device, wherein the network identity comprises one or more of:
a mobile phone number; and
an international mobile subscriber identification (IMSI) number.

10. The method of claim 9, wherein the method further comprises bypassing authentication of the user device based on the network identity of the user device.

11. The method of claim 8, wherein the bearer connection allows traffic only between the user device and an authentication server.

12. The method of claim 8, wherein the network identifier comprises an Internet Protocol (IP) address allocated by an address allocation service running on the gateway.

13. The method of claim 8, further comprising sending to the user device a service access permission indicating that the user device is permitted to initiate a connection request for accessing the requested service.

14. The method of claim 8, wherein the service access request comprises a flag or a bit pattern in a payload or header of the first message.

15. The method of claim 8, further comprising determining a cost for traffic associated with the service access of the user device, wherein a payment associated with the cost is obtained from one or more of:
an account associated with the selected service; and
a provider of a service that has been accessed by the user device.

16. A computer-implemented method for facilitating service access to a user device without a roaming subscription in a network, the method comprising:
obtaining a connection request from the user device;
providing information associated with an authentication portal to the user device, wherein the authentication portal allows a user to select a service provided in the network and enter service credentials associated with the selected service;
forwarding the service credentials obtained from the authentication portal to an Internet service server (ISS) associated with the selected service; and
in response to determining a successful authentication from the ISS, allowing data traffic between the user device and the ISS to pass.

17. The method of claim 16, wherein, in response to determining an unsuccessful authentication from the ISS, the method further comprises one or more of:
determining whether a number of times the unsuccessful authentication has been generated has reached a threshold;
in response to the number not reaching the threshold, sending an error message to the user device; and
in response to the number reaching the threshold, sending an authentication unsuccessful notification to the user device.

18. The method of claim 16, wherein the information associated with the authentication portal includes one or more of:
a list of services supported by the network;
a username field;
a password field; and
one or more additional credentials fields.

19. The method of claim 16, further comprising:
identifying a network address as a source address of the connection request; and
in response to determining a successful authentication from the ISS, recording the network address as an authenticated address in a service record.

20. The method of claim 19, wherein allowing data traffic between the user device and the ISS to pass comprises:
allowing data packets from the network address to the ISS to pass; and
allowing data packets sent from the ISS to the network address to pass.

21. The method of claim 16, further comprising collecting network statistics associated with data traffic between the user device and the ISS.
